(19) United States
(12) Patent Application Publication
(10) Pub. No.: US 2019/0169460 A1
(43) Pub. Date: Jun. 6, 2019

(54) HYDROPHOBIC COATINGS THAT INCLUDE NANOPARTICLES

(71) Applicants: Eric Loth, Charlottesville, VA (US); Ilker Bayer, Bolzaneto (IT); K Ghokulla Krishnan, Charlottesville, VA (US)

(72) Inventors: Eric Loth, Charlottesville, VA (US); Ilker Bayer, Bolzaneto (IT); K Ghokulla Krishnan, Charlottesville, VA (US)

(21) Appl. No.: 15/833,672

(22) Filed: Dec. 6, 2017

(51) Int. Cl. C09D 133/16; B05D 1/12; B05D 5/08; B05D 3/12; B05D 7/00; C09D 1/00

(52) U.S. Cl. CPC C09D 133/16; B05D 1/12; C09D 1/00; B05D 3/12; B05D 7/584; B05D 5/083

(57) ABSTRACT

A coating and related methods useful for reducing insect residue on moving surfaces, such as turbine blades or aircraft. The coating can include alternating layers of a perfluorinated acrylic copolymer and silicon dioxide nanoparticles that have been infused into one another via thermal annealing processes. The coating may be super-hydrophobic and exhibits desirable durability characteristics.

### FIELD OF THE DISCLOSURE

This document pertains generally, but not by way of limitation, to hydrophobic coatings that include nanoparticles as well as methods of constructing and using the same.

### BACKGROUND

Adhesion of insect residue to moving surfaces (e.g., turbine blades and surfaces of aircraft) can cause surface contamination problems and increased surface drag. In the context of aircraft, for example, insect fouling during takeoff and landing can disrupt the laminar flow of air along the aircraft surface thereby resulting in increased drag and fuel consumption. Solutions to these insect residue problems are needed in the art.

### OVERVIEW

The present inventors have discovered that the accumulation of insect residue can be reduced or avoided by use of coatings that provide non-wettable or hydrophobic surfaces having certain topographical and chemical features (e.g., surface roughness and hydrophobicity features).

The present invention is directed towards coatings that comprise, consist of, or consist essentially of a plurality of layers, where at least one layer comprises, consists of, or consists essentially of a perfluorinated acrylic copolymer and at least a second layer comprises, consists of, or consists essentially of silicon dioxide nanoparticles. The plurality of layers in the coating are partially infused into one another via thermal annealing processes.

In some embodiments, the present invention includes a coating on a substrate, wherein the coating comprises a first layer and a second layer. The first layer includes a perfluorinated acrylic copolymer, while the second layer includes silicon dioxide nanoparticles. The second layer is disposed adjacent to the first layer, and the first layer and the second layer are partially infused into one another.

In some embodiments, the present invention includes a method of coating a substrate, wherein the method comprises forming a first layer over the substrate, forming a second layer over the substrate, and heating the substrate. Forming the first layer includes spraying a first solution that includes perfluorinated acrylic copolymer dissolved in a first solvent. Forming the second layer includes spraying a second solution onto a surface of the first layer, wherein the second solution includes silicon dioxide nanoparticles and a second solvent. Heating the substrate results in the second layer partially infusing into the first layer, thereby forming the coating on the substrate.

In still further embodiments, the present invention includes a method of reducing insect residue on a surface. The method comprises disposing a coating according to the present invention over the surface and then allowing insects to impinge on the surface.

The inventive coatings prevent accumulation of insect residue on moving surfaces and can therefore be considered “self-cleaning”. For example, substrates on which the inventive coatings are formed accumulate negligible amounts of insect residue when the coated substrate is subjected to insect impact events in a wind tunnel (e.g., at least 100 insect impact events occurring at speeds of 50 m/sec or greater). Further, embodiments of the inventive coatings provide other advantageous physical characteristics, such as good wear and adhesion characteristics.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1C illustrate the concept of contact angles on hydrophilic, hydrophobic, and super-hydrophobic surfaces.

FIG. 2 illustrates a flow diagram showing the steps of a method of the invention.

FIG. 3 illustrates a cut-away side view of a coating of the present invention. FIG. 3 is not drawn to scale and the relative size and proportion of some of the elements are exaggerated for clarity.

FIG. 4 illustrates a cross-sectional side view of a coated substrate of the present invention. FIG. 4 is not drawn to scale and the relative size and proportion of some of the elements are exaggerated for clarity.

FIGS. 5A-5D illustrate the application of four sequential films to an aluminum substrate.

FIG. 6 illustrates a TEM image of Aerosil™ R812 fumed silicon dioxide nanoparticles.

FIG. 7A illustrates a drawing of a wind tunnel and test section used to test the coatings of the present invention.

FIG. 7B illustrates a drawing showing a close-up view of an injection tube in the wind tunnel with the airfoil and coating visible.

FIG. 8A illustrates a SEM image of a multilayer polymer-micro-particle coating of the present invention.

FIG. 8B illustrates a SEM image of a multilayer polymer nanoparticle film coating of the present invention.

FIG. 9A illustrates a SEM image of sprayed micron-scale surface topography of the outmost surface of a hydrophobic silica layer of the present invention.

FIG. 9B illustrates a SEM image showing micron scale surface topography of the outermost layer of a multilayer coating of the present invention.

FIG. 9C illustrates a 3D AFM topography image of a superhydrophobic coating of the present invention.

FIG. 9D illustrates a graph representing a roughness histogram.

FIG. 10A illustrates a schematic representation of a pencil hardness test setup along with the softness-hardness scale.

FIGS. 10B-10D each illustrate a SEM image of the surface morphology of an inventive coating.

FIG. 11A illustrates adhesion tests conducted on the inventive coatings.

FIGS. 11B and 11C each illustrates an optical microscope image of scratch lines in an inventive coating.

FIG. 11D shows a graph illustrating static water contact angle changes as well as the water droplet roll-off angles as a function of number of linear wear cycles for a tested coating of the present invention.

FIG. 11E illustrates a SEM image showing the appearance of wear marks in a tested coating of the present invention.

FIG. 12 illustrates a photograph showing three types of insect residues.

FIGS. 13A and 13B illustrate two photographs showing residue distributions on tested surfaces.

FIGS. 13C-13E each illustrate bar graphs providing results from residue analysis testing.

FIG. 13F illustrates a graph showing residue heights on two different surfaces.

### DETAILED DESCRIPTION

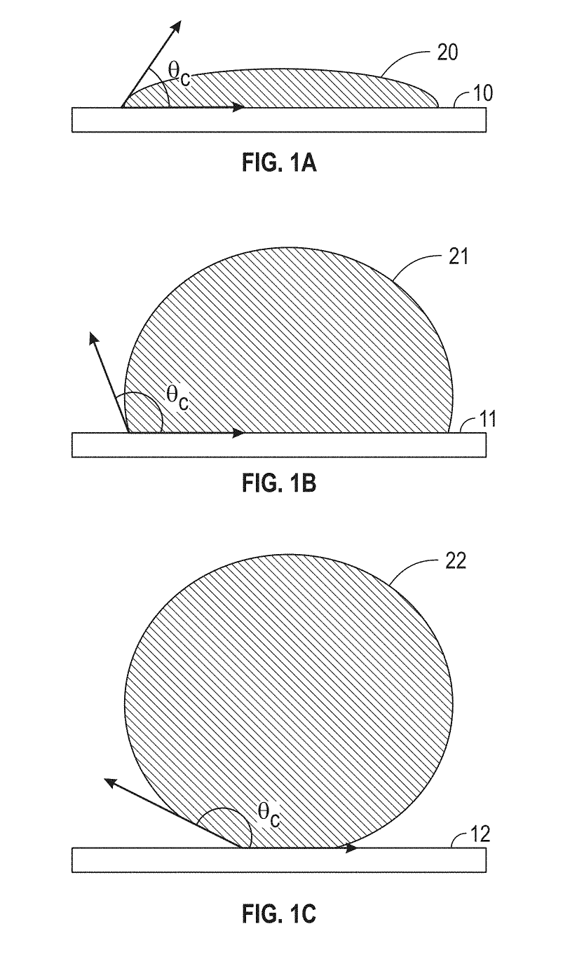

As used herein, the term “hydrophilic surface” is defined as a surface that produces a contact angle of less than 90° with a droplet of water, the term “hydrophobic surface” is defined as a surface that produces a contact angle of at least 90° but no greater than 150° with a droplet of water, and the term “super-hydrophobic surface” is defined as a surface produces a contact angle of more than 150° with a droplet of water. A “contact angle” is the angle where a liquid-vapor surface meets a solid surface and it quantifies the wettability of a solid surface by the liquid. FIGS. 1A-1C illustrate the concept of contact angles on hydrophilic, hydrophobic, and super-hydrophobic surfaces. In each of FIGS. 1A-1C, a water droplet rests on a surface and exhibits a different “contact angle”. In FIG. 1A, surface 10 is a hydrophilic surface and produces a contact angle θ_{c} with water droplet 20 that is less than 90°. In FIG. 1B, surface 11 is a hydrophobic surface and produces a contact angle θ_{c} with water droplet 21 that is greater than or equal to 90° but less than or equal to 150°. In FIG. 1C, surface 12 is a super-hydrophobic surface and produces a contact angle θ_{c} with water droplet 22 that is greater than 150°.

As used herein, the term “nanoparticles” refers to particles having a size of between 1 and 100 nanometers.

As used herein, the term “PAC” is defined as a perfluoroalkyl acrylic copolymer. An example of one class of PACs useful in the present invention are hydrophobic or super-hydrophobic PACs. Further examples of suitable PACs for the present invention include thermoplastic PACs. Yet further examples of suitable PACs for the present invention include PMCs (as defined below).

As used herein, the term “PMC” is defined as a perfluoroalkyl methacrylic copolymer. An example of one class of PMCs useful in the present invention are hydrophobic or super-hydrophobic PMCs. Further examples of suitable PMCs for the present invention include thermoplastic PMCs.

The present invention includes nanocomposite coatings comprising, consisting or, or consisting essentially of alternating layers of a hydrophobic PAC and hydrophobic surface functional silicon dioxide nanoparticles. The alternating layers are partially infused into one another. In some embodiments, the coating of the present invention is or provides a “hydrophobic” or “super-hydrophobic” surface.

Some embodiments of the inventive coatings prevent the accumulation of insect residue. For example, embodiments of the inventive coating, when formed on a substrate, prevent significant adhesion of insect residue even after 100 high-speed insect impact events (e.g., impact events occurring at 50 m/sec or greater).

In some embodiments, the invention includes methods of coating a substrate. The methods include forming a first layer over the substrate, forming a second layer over the substrate, and heating the substrate to partially infuse the first and second layers together.

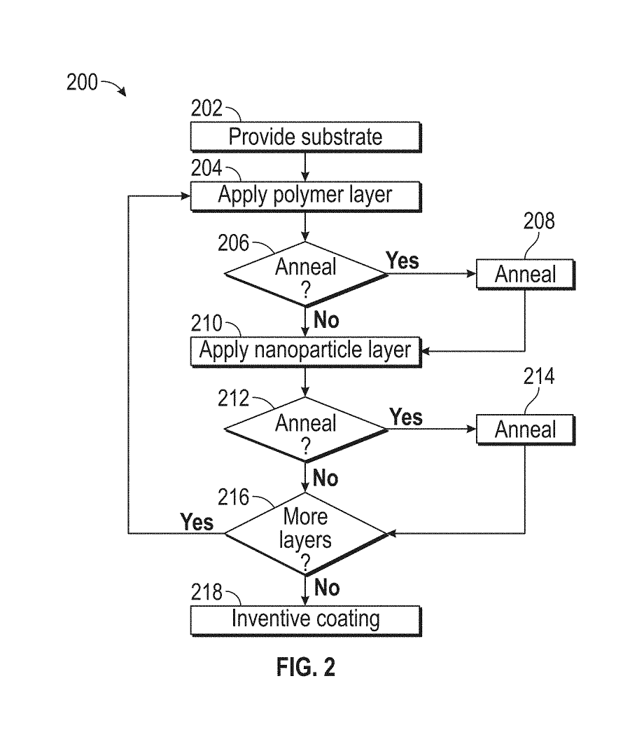

FIG. 2 illustrates a flow diagram showing the steps of method 200, which is one example of a method of the present invention. As described in further detail below, method 200 includes certain iterative portions, including steps of applying or disposing multiple layers on or over a substrate and thermally annealing the substrate and disposed layers to cause neighboring layers to partially infuse into one another.

The start of method 200 includes block 202, which includes providing a substrate on which a coating of the present invention will be formed or applied. A suitable substrate can be any solid surface that would benefit from reduced insect residue fouling. For example, the substrate may be a surface on an aircraft (e.g., an aircraft turbine blade or a portion of an aircraft's fuselage, wings, or tail) or on a moving turbine blade (e.g., a turbine on a windmill or other electrical-generating equipment). The substrate may be made of a polymer, metal (e.g., aluminum, steel, or titanium), metal alloy, or a composite material (e.g., a polymer-carbon composite material). In some embodiments, the substrate is a turbine in a jet engine of an aircraft.

At block 204 of method 200, a polymer layer is disposed or formed over the substrate. One way of forming a polymer layer over the substrate can include spraying a polymer solution directly onto the substrate so that the polymer solution is adjacent and contacting the substrate. The polymer solution may comprise, consist of, or consist essentially of a PAC (e.g., a PMC) dissolved in one or more solvents. The one or more solvents may be chosen based on their ability to dissolve the PAC while also producing a uniform coating once sprayed onto the substrate. Example of solvents that are suitable for forming the first polymer layer can include acetone, tetrahydrofuran (THF), methyl ethyl ketone (MEK), or mixtures thereof. In some embodiments of the invention, the PAC is present in the polymer solution in an amount that is between 15% and 30% by weight of the polymer solution. Optionally, the first polymer solution, and hence the first polymer layer, may additionally include silicon dioxide nanoparticles. Optionally, the PAC disposed in block 204 is the same PAC or a different PAC from any previously disposed PAC. Further, the first polymer layer disposed or formed over or on the substrate may act as a makecoat for subsequent layers. In some embodiments, the first polymer layer includes a heat-activated adhesive.

Optionally, at block 206 of method 200, the substrate and any previously disposed layer(s) may be subjected to an annealing or thermal treatment. If it is desired to subject the substrate and previously disposed layer(s) to an annealing process, then the substrate and previously disposed layer(s) are annealed in block 208 of method 200. The annealing process includes heating the substrate and any previously disposed layer(s) (e.g., polymer layers and/or nanoparticle layers) to a temperature that is at or above the glass transition temperature of the PAC of the previously disposed layer(s). The annealing process may heat the substrate and any disposed layer(s) to a temperature at or above the melting point of the PACs in the disposed layers. In some embodiments, the annealing process may heat the substrate and any disposed polymer layer to a temperature that does not exceed the onset of polymer degradation (e.g., a temperature of ˜220° C. for many types of PACs) or to a temperature that does not degrade a hydrophobic surface treatment of nanoparticles that may be present in one or more of the disposed layers (e.g., a temperature of ˜250° C. for many types of surface-treated nanoparticles). In further embodiments, the annealing process holds the substrate and any disposed polymer layers at the desired annealing temperature for a period of 5 minutes or less (e.g., for a period of 30 seconds to 1 minute).

At block 210 of method 200, a layer of nanoparticles is disposed over the substrate and onto the last disposed layer (e.g., either over an a nonannealed polymer layer from block 204 of a polymer layer that has been annealed in block 208). One way of forming a nanoparticle layer over the substrate can include spraying a nanoparticle solution directly onto the previously disposed layer(s) to dispose a layer of silicon dioxide nanoparticles over the substrate and adjacent to the last applied layer, thereby “sandwiching” the previously disposed layer(s) between substrate and the nanoparticle layer being disposed in block 210. The nanoparticle solution may comprise, consist of, or consist essentially of silicon dioxide nanoparticles suspended or dispersed in a liquid such as chloroform or in a solution of PAC dissolved in a solvent (e.g., a solvent such as acetone, THF, MEK, or mixtures thereof). If PAC is included in the nanoparticle solution disposed in block 210, the PAC may be the same or different PAC disposed in block 204.

Optionally, at block 212 of method 200, the substrate and any previously disposed layer(s) may be subjected to an annealing or thermal treatment. If it is desired to subject the substrate and previously disposed layer(s) to an annealing process, then the substrate and previously disposed layer(s) are annealed in block 214 of method 200. The annealing process includes heating the substrate and any previously disposed layer(s) (e.g., any previously disposed polymer layers or nanoparticle layers) to a temperature that is at or above the glass transition temperature of the PAC(s) of the previously disposed layer(s). The annealing process may heat the substrate and any disposed layer(s) to a temperature at or above the melting point of the PAC(s) in the previously disposed layers. Generally, it has been found that successive annealing (e.g., annealing after disposing each layer over the substrate) produces the best coatings for avoiding or shedding insect residue while also providing a more durable coating.

At block 216 of method 200, additional layers may be disposed over the substrate and any previously disposed layers. If additional layers are desired, then another polymer layer is disposed over the substrate and onto the previously disposed layer, in accordance with blocks 204 and 210 and the other subsequent blocks of method 200. Further, the substrate and its disposed layers may be subjected to annealing processes in accordance with blocks 208 and 214. In this manner, additional polymer layers and additional nanoparticle layers can be disposed over the substrate until a desired number of layers are disposed over the substrate. For example, the substrate can include 2, 3, 4, 5, 6, 7, 8, 9, 10, 11, 12, 13, 14, 15, 20, 25, 30, 40, 50, or more than 50 layers. Any of the layers of the inventive coatings can comprise, consist of, or consist essentially of a PAC and/or silicon dioxide nanoparticles. For example, the inventive coatings can comprise alternating polymer layers and nanoparticle layers.

If, at block 216 of method 200, additional layers are not desired, then the layers previously disposed over the substrate comprise the inventive coating pursuant to block 218.

The thickness of the various layers disposed over the substrate can be controlled by varying the concentration of the PAC and/or the silicon dioxide nanoparticles in the sprayed solution. Additionally, or alternatively, the thickness of the each of the various layers can be controlled by applying a given layer with multiple passes of the spraying device (e.g., two, three, four, five, six, or more than six passes of the spraying device). In some embodiments, each of the polymer layers disposed over the substrate (e.g., in accordance with block 204) can have a thickness of between 8 and 10 micrometers. Further each of the nanoparticle layers disposed over the substrate (e.g., in accordance with block 210) can have a thickness of up to 300 nanometers. In some embodiments, the total thickness of the inventive coating applied to the substrate is between 30 and 50 micrometers in thickness.

In some embodiments, the annealing processes (e.g., blocks 208 or 214) includes removing non-stick portions of the outer layer (e.g., a nanoparticle layer or a polymer layer) prior to disposing further layer over the substrate. For example, the non-stick portions of the outer layer may be removed with the use of a pressure dust gun after the substrate and applied layers have undergone a heat treatment.

In some embodiments, a layer of the inventive coating is sprayed over the substrate while a previous layer is in a melted or semi-solid state. For example, at blocks 204 or 210, the respective polymer or nanoparticle layer may be applied while the a previously annealed layer (e.g., a previously applied and annealed polymer or nanoparticle layer) is at a temperature that is above the previously annealed layer's glass transition temperature or melting point of a PAC in the previously annealed layer.

In some embodiments, the present invention includes a coating on a substrate. For example, the present invention includes a coating formed by one of the methods described herein.

In some embodiments, the inventive coating includes at least one polymer layer and at least one nanoparticle layer.

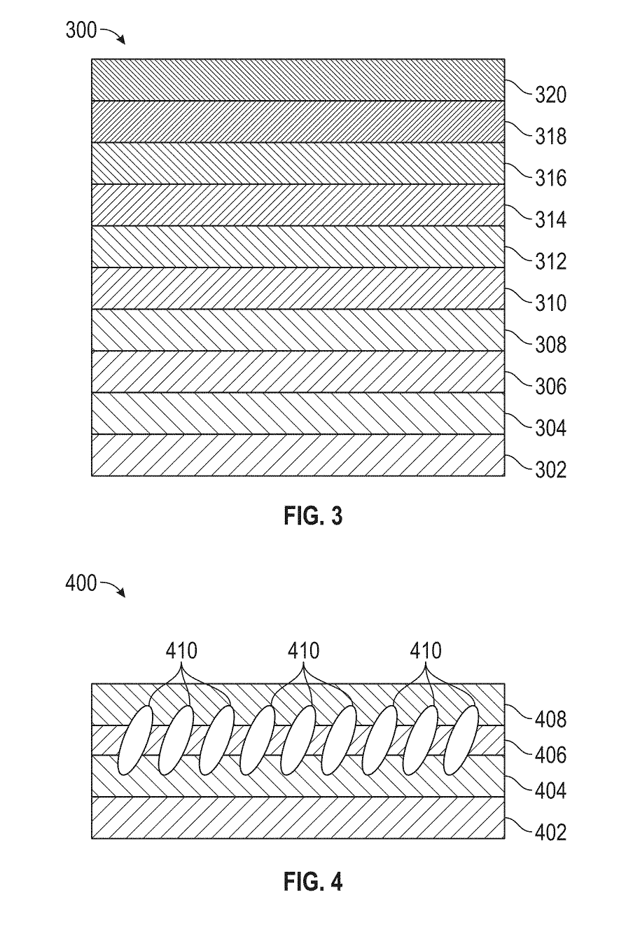

FIG. 3 illustrates one embodiment of the present invention in the form of coated substrate 300. Coating substrate 300 includes a substrate layer 302 over which are disposed a plurality of layers 304, 306, 308, 310, 312, 314, 316, 318, and 320. (The illustration of FIG. 3 is not to scale.)

Substrate 302 can be any solid surface that would benefit from reduced insect residue fouling. For example, substrate 302 may be a surface on an aircraft (e.g., an aircraft turbine blade or a portion of an aircraft's fuselage, wings, or tail) or on a moving turbine blade (e.g., a turbine on a windmill or other electrical-generating equipment). Substrate 302 may be made of a polymer, metal (e.g., aluminum, steel, or titanium), metal alloy, or a composite material (e.g., a polymer-carbon composite material). In some embodiments, the substrate is a turbine in a jet engine of an aircraft.

Layer 304 is a polymer layer that is disposed over and adjacent to substrate 302. Layer 304 comprises, consists of, or consists essentially of a PAC. Optionally, layer 304 includes silicon dioxide nanoparticles. Layer 304 may act as a makecoat for the other layers disposed over substrate 302 (e.g., layers 306, 308, 310, 312, 314, 316, 318, and 320). In some embodiments, layer 304 includes a heat-activated adhesive.

Layer 306 is a layer of nanoparticles disposed over substrate 302 and adjacent to layer 304. Layer 306 comprises, consists of, or consists essentially of silicon dioxide nanoparticles and, optionally, a PAC. If a PAC is included in layer 306, the PAC may be the same or different than the PAC in layer 304.

Optionally, the inventive coatings can include additional layers beyond a first polymer layer and a first nanoparticle layer such that the inventive coatings include alternating polymer and nanoparticle layers. For example, and as illustrated in FIG. 3, coated substrate 300 additionally include layers 308, 310, 312, 314, 316, 318, and 320. Layers 308, 312, 316, and 320 can be polymer layers that comprise, consist of, or consist essentially of a PAC. Layers 310, 314, and 318 can comprise, consist of, or consist essentially of silicon dioxide nanoparticles and, optionally, a PAC. The PAC included in any of the layers of coated substrate 300 can be the same or different as the PAC included in other layers of coating substrate 300.

While coated substrate 300 includes a total of nine layers (five polymer layers in the form of layers 304, 308, 312, 316, and 320 and four nanoparticle layers in the form of layers 306, 310, 314, and 318), the present invention also includes coatings or coated substrates that have more or fewer than nine layers. For example, coating of the present invention can include 2, 3, 4, 5, 6, 7, 8, 9, 10, 11, 12, 13, 14, 15, 20, 25, 30, 40, 50, or more than 50 layers. Any of the layers of the inventive coatings can comprise, consist of, or consist essentially of a PAC and/or silicon dioxide nanoparticles. For example, the inventive coatings can comprise a plurality of alternating polymer layers and nanoparticle layers.

The thickness of the various layers of the inventive coatings can vary according to the demands and needs of a given application. For example, the polymer layers of the inventive coatings (e.g., any of layers 304, 308, 312, 316, or 320) can have a thickness of between 8 and 10 micrometers. Each of the nanoparticle layers of the inventive coatings (e.g., any of layers 306, 310, 314, 318) can have a thickness of 300 nanometers or less. In some embodiments, the total thickness of the inventive coating is between 30 and 50 micrometers in thickness.

As described above, the coatings of the present invention are subjected to one or more thermal or annealing processes to partially infuse the nanoparlticles of a nanoparticle layer into neighboring layers (e.g., neighboring polymer layers). FIG. 4 illustrates a cross-sectional side view of coated substrate of the present invention that includes nanoparticles that have been partially infused into neighboring polymer layers. Polymer layers 408 and 404 and nanoparticle layers 404 have been disposed over substrate 402 in accordance with the coating methods described herein. As illustrated in FIG. 4, nanoparticle layer 406 has been partially infused into neighboring polymer layers 408 and 404 because of one or more thermal annealing processes such that at least a portion of nanoparticles 410 of nanoparticle layer 406 jut or otherwise extend into one or both of neighboring polymer layers 404 and 408.

The present invention will be illustrated in the following nonlimiting examples:

### EXAMPLE 1

### Preparation of Inventive Coatings and Experimental Set Up

Capstone™ ST-100 was acquired from E.I du Pont de Nemours and Company (Wilmington, Del.). Capstone™ ST-100 it is an aqueous dispersion of PMC believed to contain 74-81% water and 19-26% of PMC. Initial tests revealed that the Capstone™ ST-100 dispersion would not make a suitable coating of the present invention due to the presence of surfactants used to maintain a stable polymer dispersion in the water. Therefore, the PMC was precipitated and re-dispersed in other solvents to enable spraying of the PMC. To accomplish this, the PMC was precipitated by mixing equal volumes of Capstone™ ST-100 and trifluoroacetic acid (acquired from Sigma-Aldrich Corporation of St. Louis, Miss.) to disrupt the colloidal stability of the PMC in the Capstone™ ST-100. Upon precipitation, the supernatant was decanted and the polymer precipitate (in the form of a rubbery state) was washed several times with water and ethanol and dried in a plastic desiccator.

Acetone was found to be a suitable solvent for the precipitated PMC as it was able to produce uniform coatings. The addition of other co-solvents with higher boiling points than acetone (e.g., THF and MEK) allowed for the spraying of more uniform polymer layers. The most suitable solvents. Solutions with concentrations from 15 to 30 wt. % of PMC in acetone were prepared in increments of 5%. To prepare the polymer/nanoparticle composites or just the nanoparticle films, commercially available hydrophobic fumed silica nanoparticles (e.g., Aerosil™ R812, available from Evonik Industries AG of Essen, Germany) were either dispersed in the PMC/acetone solutions or separately dispersed in chloroform. Polymer/nanoparticle solutions were sonicated in an ultrasonic bath for 30 minutes before spray coating. Polymer, polymer/nanoparticle, and nanoparticle solutions were sprayed onto aluminum substrates using an internal mix, double action airbrush atomizer (model VL-SET acquired from Paasche Airbrush Company of Harwood Height, Ill.). The thickness of the polymer or nanoparticle films were independently controlled by varying the concentrations of polymer and/or nanoparticles in their respective solutions as well as varying the number spray passes used to deposit the respective films.

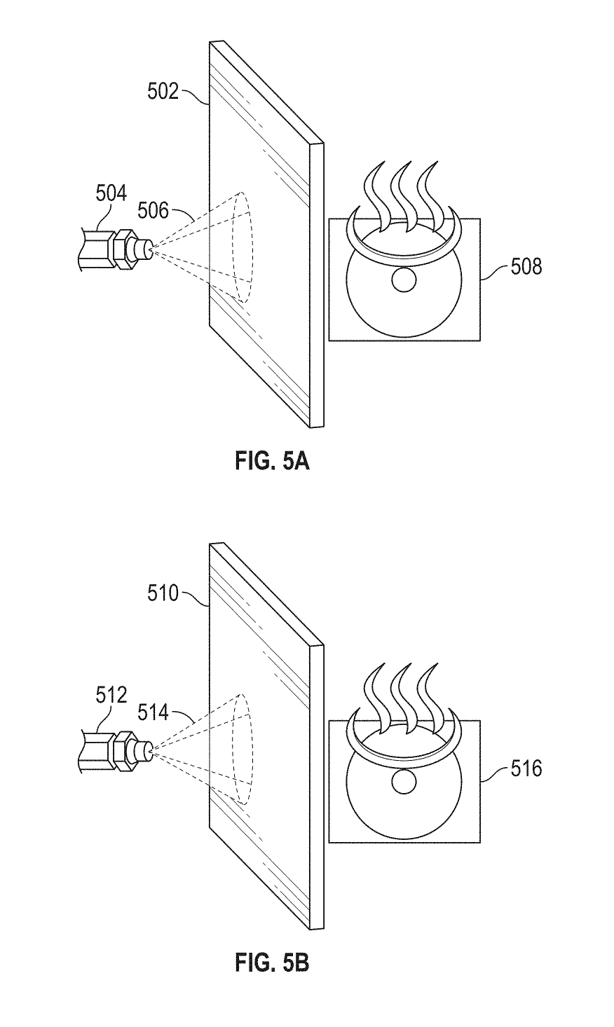

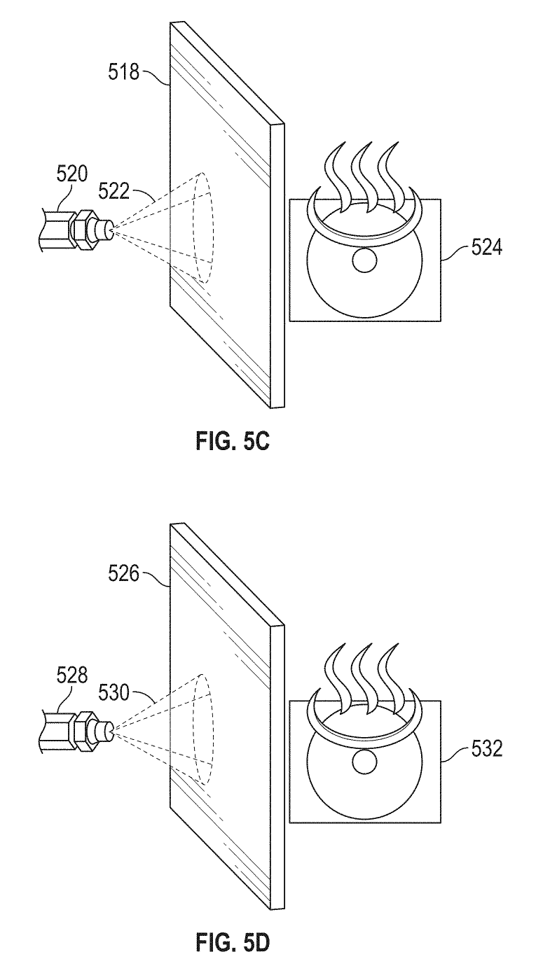

The inventive coatings for insect impact experiments were prepared on aluminum surfaces by spray painting alternating layers of PMC and silica (SiO2) nanoparticles as shown in FIGS. 5A-5D. FIGS. 5A-5D illustrate the application of four sequential films to an aluminum substrate.

As illustrated in FIG. 5A, a first polymer solution 506 was sprayed via sprayer 504 onto aluminum substrate 502. The first polymer-sprayed substrate 502 was then subjected to a thermal annealing process 508 to form a first polymer film disposed over substrate 502.

Next, and as shown in FIG. 5B, a first nanoparticle solution 514 was sprayed via sprayer 512 onto the first polymer-coated substrate 510. The first nanoparticle-sprayed substrate 510 was then subjected to a thermal annealing process 516 to form a first nanoparticle film disposed over substrate 510.

Next, and as shown in FIG. 5C, a second polymer solution 522 was sprayed via sprayer 520 onto the first nanoparticle-coated substrate 518. The second polymer-sprayed substrate 518 was then subjected to a thermal annealing process 524 to form a second polymer film disposed over substrate 518.

Next, and as shown in FIG. 5D, a second nanoparticle solution 530 was sprayed via sprayer 528 onto the second polymer-coated substrate 526. The second nanoparticle-sprayed substrate 526 was then subjected to a thermal annealing process 532 to form a second nanoparticle film disposed over substrate 526.

The thickness of the polymer layers, once dry, was kept around 8-10 μm. After preliminary tests, a desired final nanoparticle layer thickness was determined to be 300 nm or less. While FIGS. 5A-5D illustrate the application of four sequential polymer and nanoparticle films onto an aluminum substrate, additional numbers of layers were also tested. As many as 6 alternating layers were applied and it was found that a minimum of 4 layers performed the best in repelling impacting fruit flies. Between each step, the thermal annealing treatments were conducted at a temperature sufficient to melt the thermoplastic polymer to ensure that at least a portion of the nanoparticle film was embedded or partially infused into the polymer matrix.

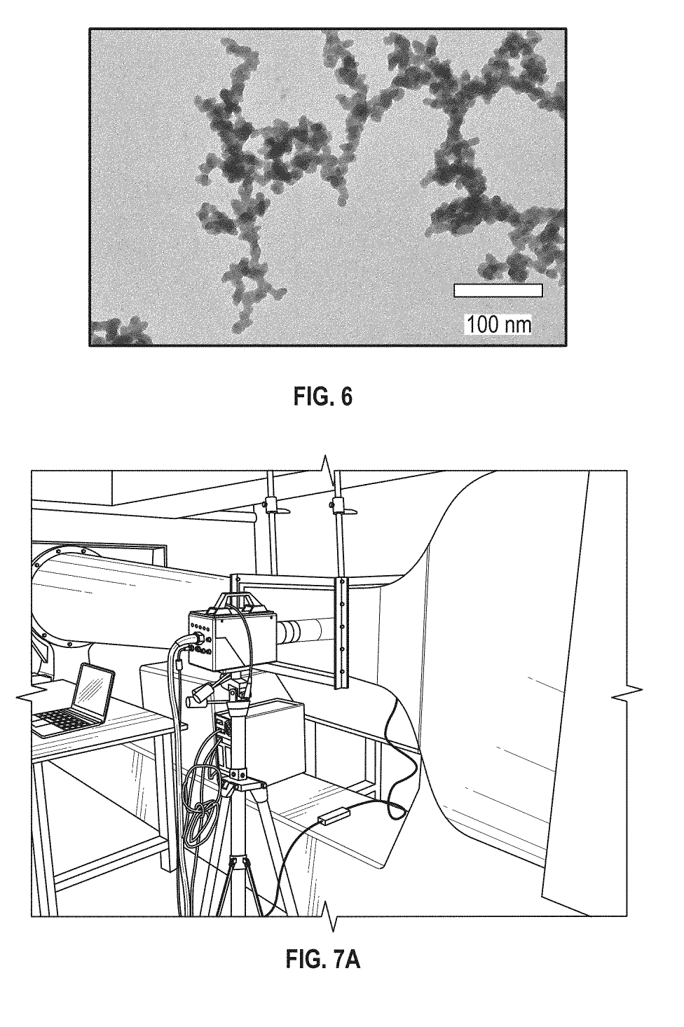

The morphology of the produced coatings was characterized by two different scanning electron microscopes (SEM): JEOL JSM-6490LA and JEOL 6700F FESEM microscopes working in high-vacuum mode, with an accelerating voltage of 10-20 kV. For scanning electron microscopy measurements, samples were coated with a 12 nm thick layer of Au/Pd to reduce surface charging. Where necessary, samples were tilted at various angles to bring out differences in morphology. Transmission electron microscopy (TEM) was performed with a JEOL JEM-1011 under an accelerating voltage of 100 kV. All the samples for TEM analysis were prepared by immersing carbon-coated 200 mesh, 50 μm copper grids in the nanoparticle dispersions, and then allowing to dry overnight under inert atmosphere. A representative TEM image of the as-received Aerosil™ R812 fumed silicon dioxide nanoparticles is shown in FIG. 6.

Atomic force microscopy (AFM) measurements were performed with a Park Systems XE-100 (from Park Systems Corporation, Suwon, Korea) in noncontact mode to measure the surface roughness of the coating before installing in the wind tunnel. At least three different zones were chosen on each sample to extract the average roughness values and at least three different samples were measured. Acquired AFM topography images were processed by public domain software known as WS×M developed for data acquisition and processing in scanning probe microscopy.

To measure the contact angle, roll-off angle, and contact angle hysteresis of the coatings, solutions were spray painted on 25×50 mm pieces of 25 μm thick aluminum. Five contact angle measurements were taken on random locations of the coatings with 10 μL deionized water droplets using a contact angle goniometer (OCA 20, Data Physics Corporation of San Jose, Calif.) equipped with a charge-coupled device (CCD) camera and image processing software. Reported contact angle measurements were averages of five measurements on each sample. Roll-off angle and contact angle hysteresis were measured five times at random locations, and their average, minimum, and maximum values are reported.

Linear abrasion experiments were conducted with a Taber™ Linear Abraser 5750 (Taber Industries, North Tonawanda, N.Y.). The applied weight was 0.35 kg with stroke length of ˜5 cm and stroke speed of 15 cycles/min. The abradant used was Calibrase Disk (CS-10F) with a base diameter of approximately 1.5 cm, which is a resilient disk composed of a binder and aluminum oxide abrasive particles that offers a mild abrading action designed to operate under loads of 0.25 to 0.5 kg corresponding to roughly 13 kPa to 29 kPa abrasion pressures, respectively. The CS-10F abradant is typically used to test safety glazing materials and transparent plastics against abrasion induced transparency losses. In this work, the corresponding abrasion pressure is 17.5 kPa under 0.35 kg of applied weight.

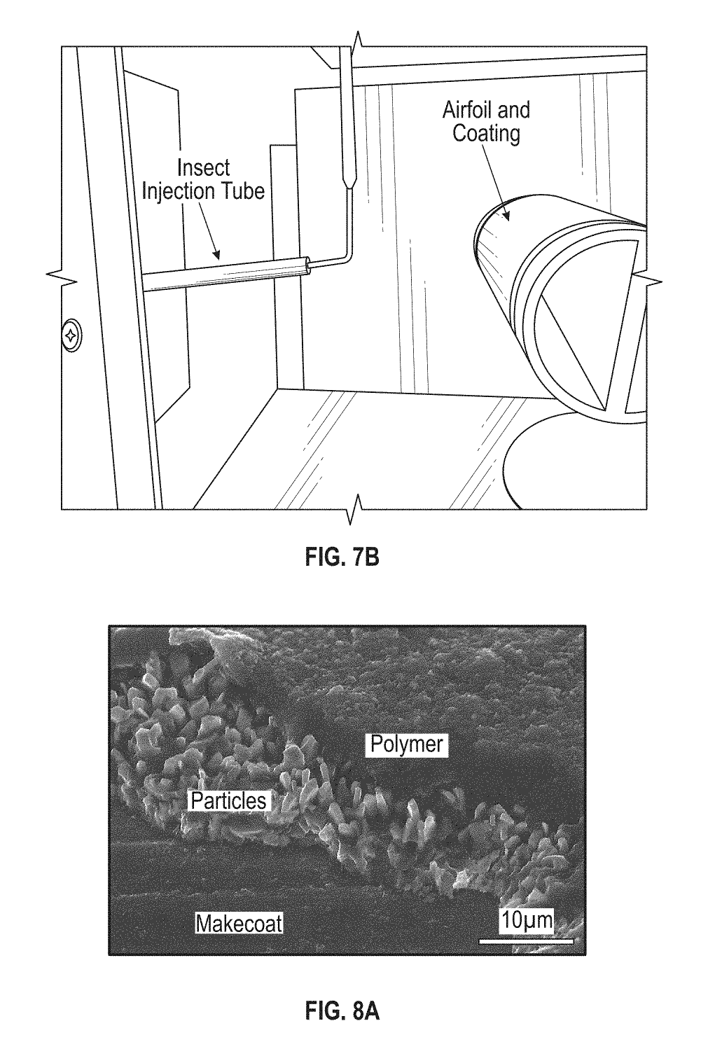

The experimental setup for insect impact outcome analysis used in this study is shown in FIG. 7A and consists of a wind tunnel, airfoil, high-speed camera (Photron SA4, USA running at 3600 fps or higher when necessary), light source and injection tube. A symmetric modified NACA0038 airfoil with a chord length of 21 cm and leading edge radius (R) of 4.0 cm was used in this study. The wind tunnel cross section was 31 cm×31 cm.

Based on previous studies, flightless fruit flies of the order Diptera were chosen as a representative insect. The flightless fruit flies were obtained from a local pet store and had an average mass of 0.7 mg. Approximating these fruit flies as ellipsoids, the fruit flies were measured to have axis diameters of d1=2.01 mm (length-wise), d2=0.92 mm (span-wise) and d3=0.85 mm (height-wise). This gives an equivalent volumetric diameter (d) of 1.16 mm. The density of the fruit fly was calculated to be 850 kg/m³. The fruit flies were fed upstream of the wind tunnel inlet into a clear Tygon™ tube with outer diameter of 9.5 mm. Compressed air was employed using a Venturi nozzle so that the insects reached a velocity of 47 m/s in the test section (obtained from high-speed video analysis), a speed which corresponded to the test section air flow speed. The injection tube exit was placed 18.5 cm away (˜90 body lengths) from the stagnation point of the airfoil. This distance minimized the wake effects arising from the injection tube itself. The insects were released in batches of 5 at a time until a total insect release of 50 (i.e. 10 batches of 5 fruit flies) or until a congested strike zone was observed on the coating. A congested strike zone is defined as enough visible insect residues on the coating where an additional impact may have a significant likelihood of occurring on top of a pre-existing residue instead of the coating. This was done so that all impacts occurred on the uncontaminated portion of the coating as opposed to a pre-existing residue since the goal of the study was to quantify the effectiveness of the coating. At least two similarly prepared replicates (two sheets cut from a larger piece) of each coating were tested in the wind tunnel for consistency in the results. After 50 insect releases, the coated surface was removed from the wind tunnel and optically analyzed and afterwards another set of 50 insects were impacted on an identical surface. In total 100 insect impact events were allowed on each surface. The insect residues accumulated on the surfaces were characterized using a Hirox KH-7700 digital microscope (Hirox-USA, Inc., of Hackensack, N.J.). FIG. 7A illustrates a drawing of the wind tunnel and test section with transparent side windows, while FIG. 7B illustrates a drawing showing a close-up view of the injection tube in the wind tunnel with the airfoil and coating visible.

### EXAMPLE 2

### Surface Topography and Roughness

The makecoat (e.g., the first polymeric layer applied to a substrate) can be a thermoplastic polymer or a heat activated adhesive. The PMC polymer can be melted and cooled repeatedly and demonstrated good adhesion to the substrate. The nanoparticle film can be applied while the makecoat is melted or in a semi-solid state so that a layer of nanoparticles can be embedded into the makecoat (polymer) layer.

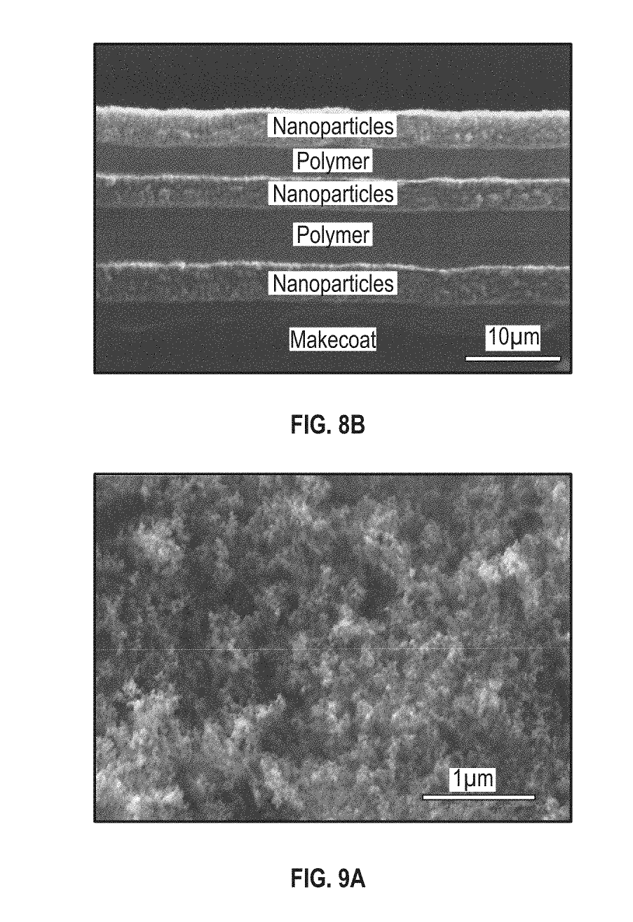

FIGS. 8A and 8B show SEM images of multilayer coatings fabricated both by micron sized particles (FIG. 8A) and nanoparticles (FIG. 8B). FIG. 8A illustrates a SEM image of a multilayer polymer-micro-particle coating while FIG. 8B illustrates a SEM image of a multilayer polymer nanoparticle film coating. The thickness of the nanoparticle film can be adjusted by either changing the concertation of the nanoparticles in the spray solution or by decreasing the number of spray passes over the substrate during the spray application. Spray application and the solution concentration were adjusted such that coatings made by six or more alternating layers featured a total thickness of 30-50 μm. In the example shown in FIG. 8B, the coating has a net thickness of ˜30 μm.

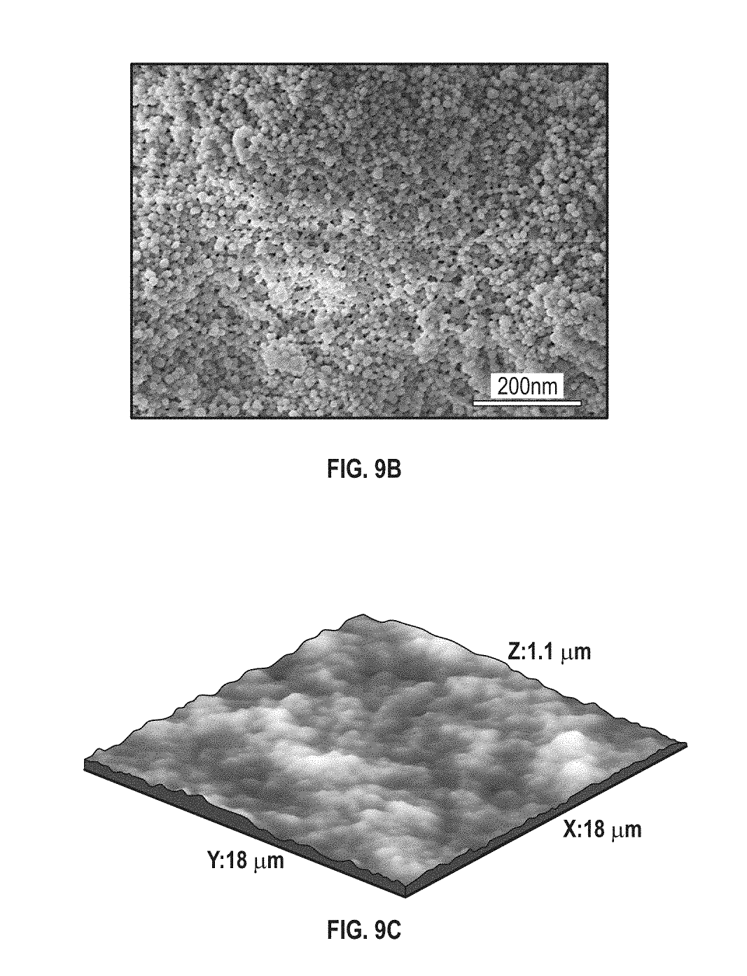

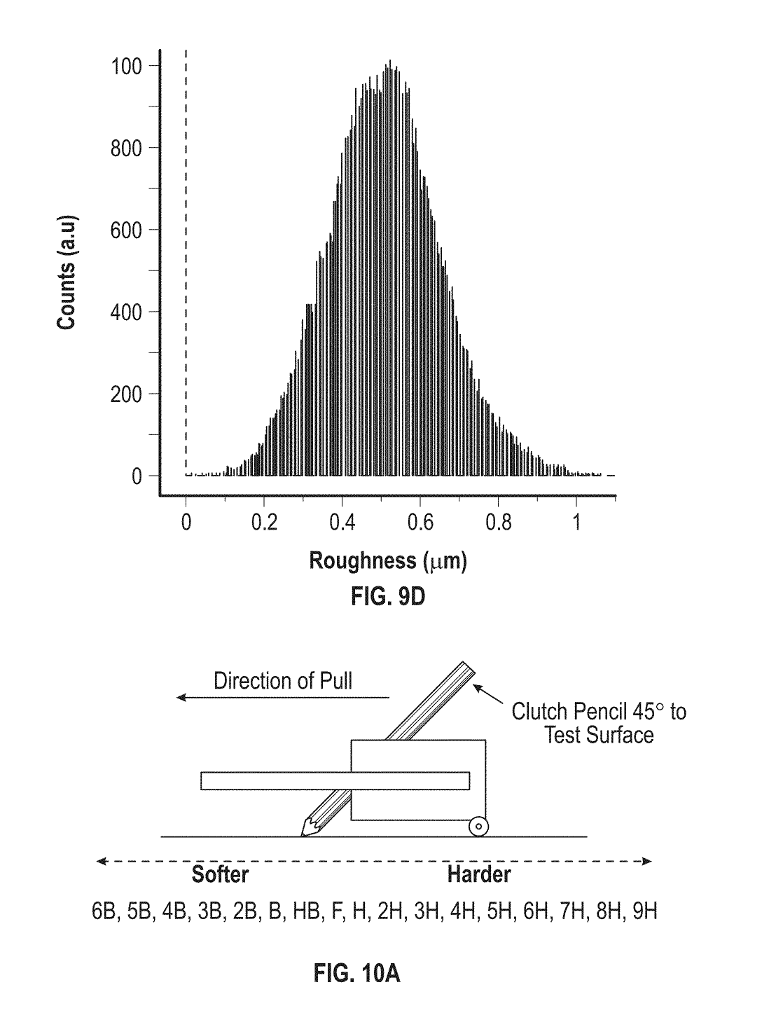

FIG. 9A illustrates a SEM image of sprayed micron-scale surface topography of the outmost surface of a hydrophobic silica layer just after it was spray deposited and before thermal treatment. If no thermal treatment is used, this nanoparticle film could be easily removed from the surface.

FIG. 9B illustrates a SEM image showing micron scale surface topography of the outermost layer of a multilayer coating after thermal annealing. Upon thermal treatment and removal of the non-stick portion of the nanoparticles by pressure dust gun, the morphology of the nanoparticle film changes drastically as shown in FIG. 9B. After the final thermal treatment, just before installing in the wind tunnel for insect impact experiments, the average surface roughness of the superhydrophobic coatings was determined to be around 500 nm by AFM measurements.

FIG. 9C illustrates a 3D AFM topography image of the superhydrophobic coating before testing (without insect residue). FIG. 9D illustrates a graph representing the roughness histogram obtained from the topography image of FIG. 9C. Based on several AFM measurements on different surfaces produced by the same fabrication process, the average surface roughness was determined to be approximately 500 nm.

### EXAMPLE 3

### Abrasion Wear, Adhesion, and Water Soaking

The mechanical durability of the inventive multilayer coatings was evaluated using dry pencil hardness test, dry and wet tape adhesion, and by Taber linear abraser. The target was to develop a coating with minimum 2B pencil hardness and a tape adhesion rating above 4B.

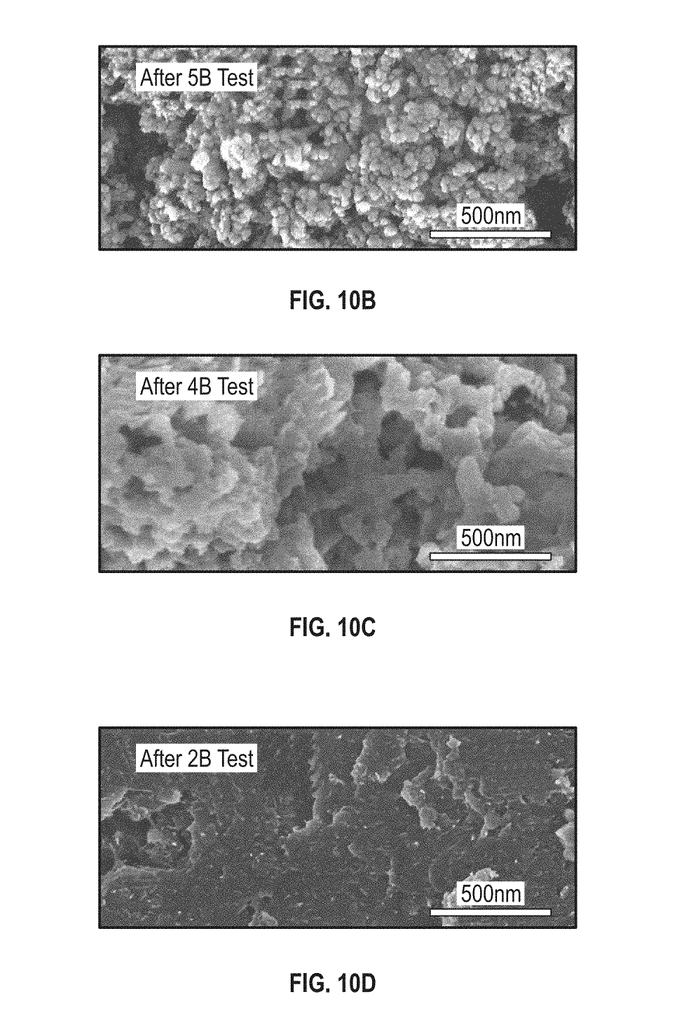

According to ASTM D336343 pencil hardness test method, a pencil with quantified hardness is dragged on the surface to be tested. Generally, the pencil is held in a carriage that is 45° and is pressed firmly on the surface while moving along it at a constant speed. FIG. 10A illustrates a schematic representation of such a pencil hardness test setup along with the softness-hardness scale. The maximum pencil hardness that the surface can withstand before the pencil leaves a permanent mark is associated with its mechanical durability. The pencil hardness scale ranges from 10B (softest) to 10H (hardest). However, in general for testing the scale from 6B to 9H is used.

FIG. 10B illustrates a SEM image of the surface morphology of an inventive coating after 5B pencil hardness test. FIG. 10C illustrates a SEM image of the surface morphology of an inventive coating after 4B pencil hardness test. FIG. 10D illustrates a SEM image of the surface morphology of an inventive coating after a 2B pencil hardness test, with flattening of the surface features clearly visible as compared to the images in FIGS. 10B and 10C.

In FIG. 10B, the 5B pencil hardness test resulted in no visible wear or scratch marks and the multi-layer coatings remained superhydrophobic. In FIG. 10C, the 4B pencil hardness test results in disruption of the initial surface morphology, however, the resultant surface features are sufficient to maintain a superhydrophobic state. Application of a 3B pencil hardness test on the multi-scale surface results in a similar morphology as that shown in FIG. 10C. However, the same experiment with a 2B pencil causes substantial removal of the nanoparticle layer and exposure of the underlying polymer coating, as shown in FIG. 10D. Hence, the multi-layer inventive coatings can withstand up to 2B hardness while maintaining hydrophobicity with negligible contact angle hysteresis. In other words, zones damaged by the 2B pencil abrasion lost their superhydrophobic state (static water contact angles were reduced to 140-145° levels), but, nonetheless, 10 μL droplets still slid off these damaged surfaces with negligible contact angle hysteresis but at tilt angles close to 40°.

After the pencil hardness testing, a tape peeling test was applied according to ASTM D3359 Method B46. Although the tape peel test was designed to test overall adhesion to the substrate for coatings, tape removal on superhydrophobic surfaces can also lead to partial destruction of the micro/nano-scale topography and thus the wetting properties are evaluated after each peeling cycle. In that sense, this test evaluates both adhesion to the substrate and cohesive adhesion. Tapes are classified according to the values of adhesion force to a reference substrate, reported as adhesion to steel in N/m. As this parameter (force/distance) increases, the tape peeling test becomes more destructive to the coating under investigation. In summary, the present coatings were first scratched with pencils of various hardness, then tested for dry tape peel adhesion, and then soaked in water for one day after which the tape peel tests were repeated.

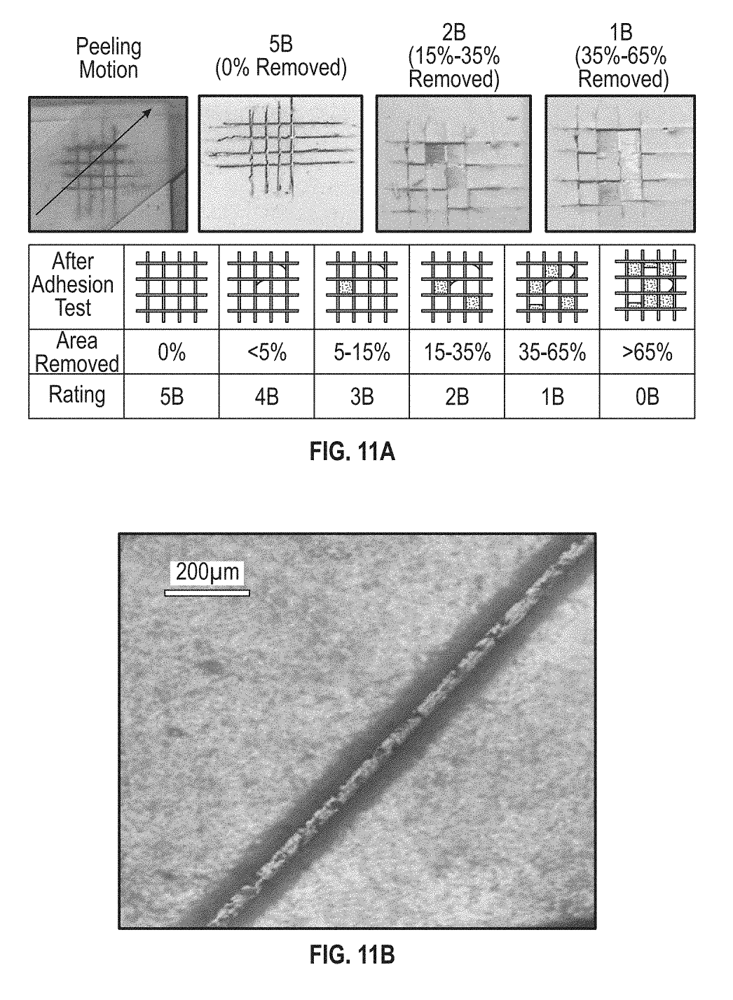

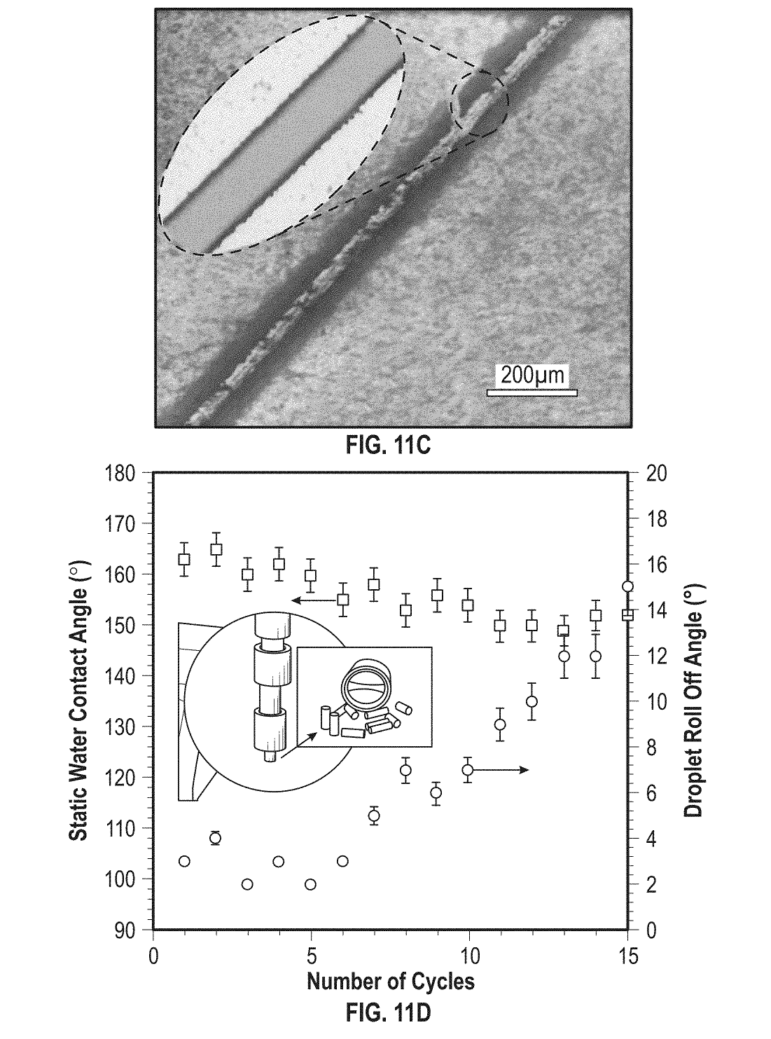

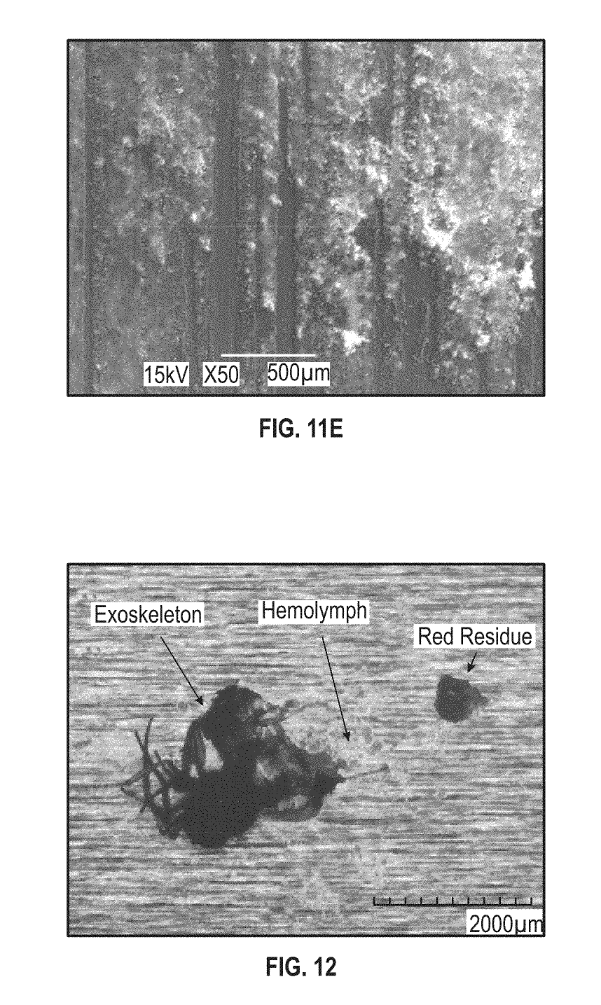

FIG. 11A illustrates adhesion tests conducted on the inventive coatings disposed over aluminum substrates. An adhesive tape was applied on the coating at a 45° angle relative to the cross-hatch cuts. After about one minute, the tape was peeled off and the sample was inspected. FIG. 11A also illustrates an indicative chart showing damaged zone schematics after the adhesion test and their corresponding ratings according to ASTM D3359. FIG. 11B illustrates an optical microscope image of the scratch line before the tape peel test, while FIG. 11C illustrates an optical image of the undamaged scratch line after the tape peel test conforming to a 2B rating. The insert in FIG. 11C shows the undamaged edge details after the tape peel test.

Approximately, 20% of the crosshatch patterns made by the 2B pencil were picked up by the tape peel action as seen FIG. 11A. The rest of the crosshatch zone was undamaged as shown in the microscope images in FIG. 11C. Over the undamaged zones, no debris was detected after the tape peel action. Hence, in terms of adhesion strength to the metallic substrate (aluminum), the inventive coatings can be classified as rated 2B.

Next, the wear abrasion resistance of the inventive coatings under linear wear cycles was examined. One of the most common durability testing methods for superhydrophobic coatings is cyclic wear abrasion tests. The test was made by attaching a selected sandpaper grade at the bottom of a metallic weight (or vice versa) and by pulling this weight along the non-wetting surface (or vice versa) for a certain distance and repeating this process in cycles. Wear abrasion resistance depends on the type of the abradant (sandpaper, cloth etc.) and the weight or applied pressure used for the testing.

FIG. 11D shows the static water contact angle changes as well as the water droplet roll-off angles as a function of number of linear wear cycles up to 15 cycles under 17.5 kPa load. As the number of cycles approached 15, the water droplet mobility on the surface declined which is an indication of 17.5 kPa wear abrasion. The inset drawing in FIG. 11D shows the abrasion arm of the tester at the tip of which an abrading cylinder is mounted. FIG. 11E illustrates a SEM image showing the appearance of wear marks at the end of 15 cycles under 17.5 kPa.

Although, a number of wear marks was observed at the end of the 15th cycle on the surface, the scratched surface remained superhydrophobic. However, droplet roll-off angles increased close to 20°, indicating considerable decline in droplet mobility over the surface.

### EXAMPLE 4

### Wind Tunnel Tests

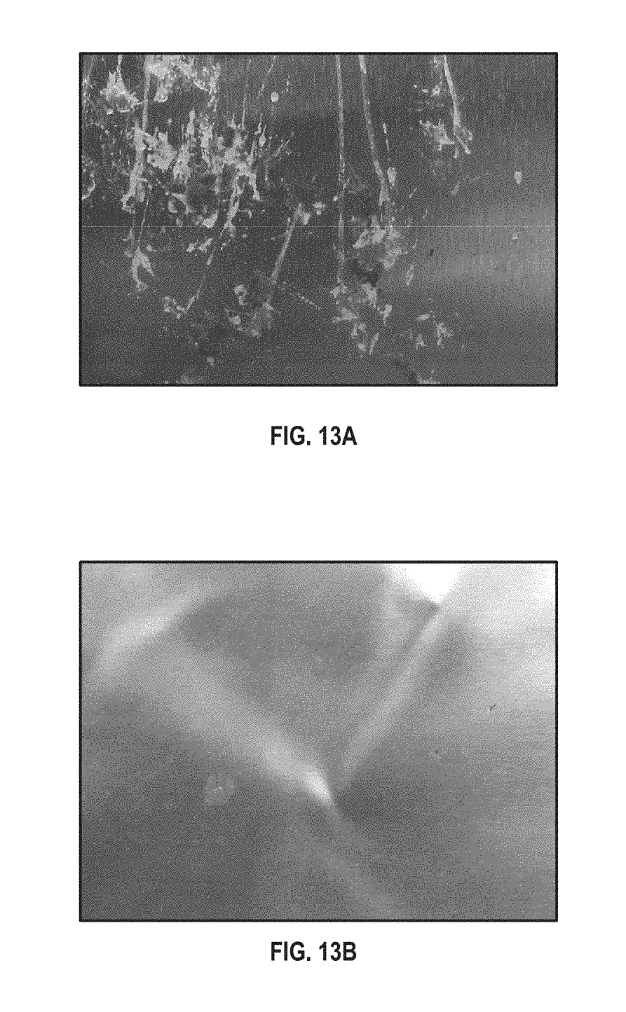

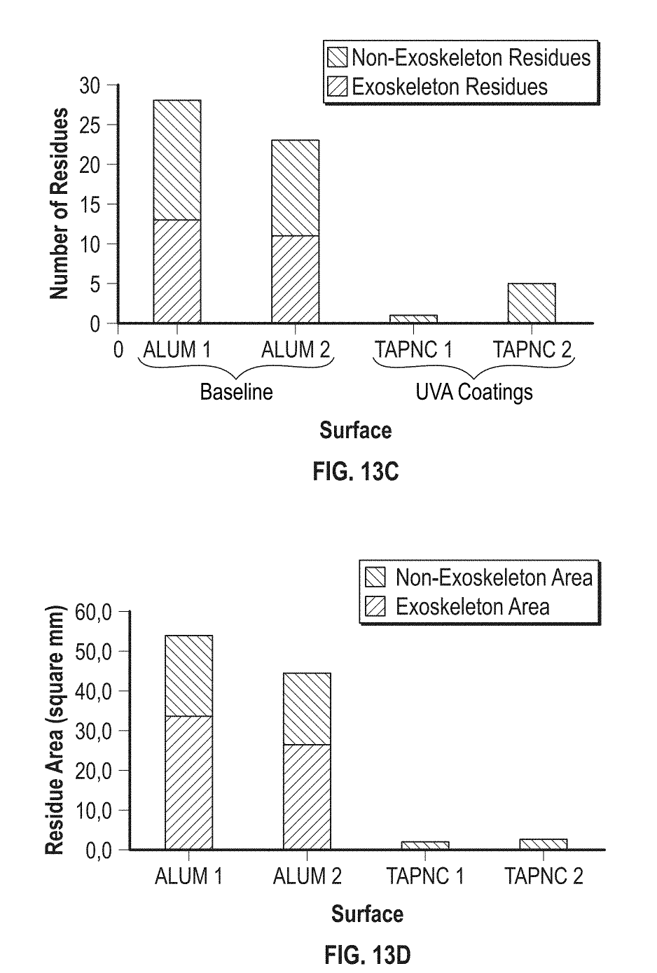

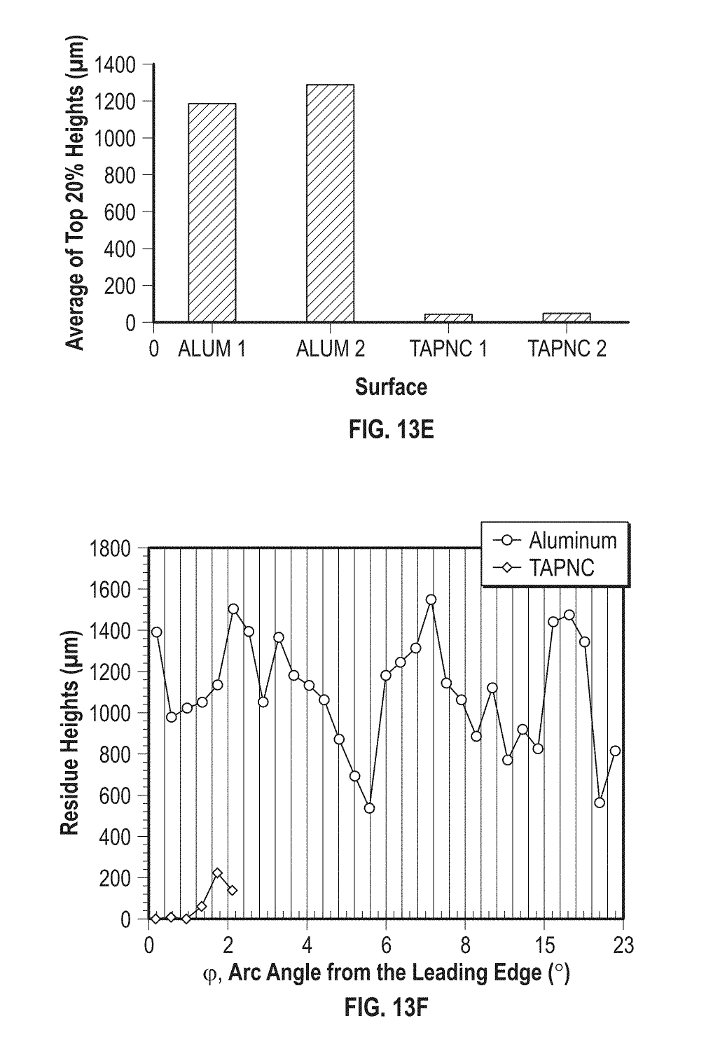

Three types of insect residues were observed from the wind tunnel testing and are shown in the photograph of FIG. 12: i) exoskeleton, ii) hemolymph and iii) red residue. FIGS. 13A and 13B illustrate two photographs showing resultant residue distributions on bare aluminum and a coating of the present invention, respectively. The photographs were taken after wind tunnel experiments in which 50 flightless fruit flies were released upstream and impacted the surfaces at 40-50 m/s. On average, of the 50 flies released per coupon, about 40 of these strike the airfoil cylindrical leading edge.

As clearly seen in FIG. 13B, the inventive coating features no exoskeleton residue compared to the baseline aluminum surface shown in FIG. 13A. Only a few hemolymph fluid stains can be seen on the superhydrophobic surface of the inventive coating in FIG. 13B. The aluminum surface in FIG. 13A has many residues, such as exoskeletons, hemolymph, and red fluid stains.

Comparative quantitative residue analysis between the surfaces photographed in FIGS. 13A and 13B are depicted in each of FIGS. 13C-13E.

FIG. 13C shows a plot of the number of residues collected on both surfaces (FIG. 13C and subsequent figures may refer to the inventive coatings as “TAPNC” or “UVA Coatings”). As baseline two aluminum surfaces were tested and as superhydrophobic coatings, two separately fabricated coatings of the present invention were tested. As mentioned above, 50 insects were allowed to impinge on the surfaces at velocities close to 50 m/s. The surfaces with the inventive coatings only exhibited fluid residue and no exoskeleton residue was observed. Further, the area of accumulated residue is significantly less on the surfaces bearing the inventive coatings, as shown in FIG. 13D, and is made up of hemolymph with no exoskeletons.

Due to the contamination of the surfaces by insect residue, the surface roughness increases. This increase in surface roughness can be quantified and compared by calculating the top 20% residue height for both the aluminum and inventive coating surfaces. FIG. 13E illustrates such a quantification of the surface roughness, which clearly shows that the surface roughness of the aluminum test surfaces increased to a much larger extent than the surface roughness of either inventive coatings.

Table 1 provides a summary of the performance of the coatings tested against the bare aluminum surfaces:

TABLE 1
Insect impact residue statistics on aluminum
compared to inventive coatings

| | Total | Number | Residue | Exoskeleton | Average top |
|---|---|---|---|---|---|
| | number | of exo- | area | area | 20% height |
| Surface | of residues | skeletons | (mm²) | (mm²) | (μm) |
| Aluminum | 25.5 | 12 | 42 | 28 | 1240 |
| TAPNC | 3 | 0 | 2 | 0 | 20 |

The inventive coating had no exoskeleton attachment but some hemolymph fluid stains. The total area associated with residues and fluid stains are twenty times less on the inventive coating as compared to the aluminum surface. For the residues that make up of the top 20% highest roughness height, the inventive coating have only 20 μm whereas the aluminum surface has heights exceeding 1 mm. Hence, the inventive coating had a two order magnitude reduction in the roughness caused by insect impact on the surfaces.

Residue accumulation can be regarded as an additional undesired roughness, which may be measured as individual residue heights. Collectively, the resultant residue height can be quantified in several different ways such as the average residue height on each surface. However, since the amount of residue and number of insect impacts can vary from experiment to flight test, a scalable quantitative way was sought that would make the reported residue height more relevant to future flight tests where the number of insect impacts is not closely controlled. FIG. 13F depicts a graph showing residue heights on two different surfaces, namely aluminum and the inventive coating as a function of arc angle (φ) from stagnation line on the leading edge radius. As can be seen in FIG. 13F, compared to the aluminum surface insect residue heights are much lower on the TAPNC surface, on average below 200 microns. Moreover, on the aluminum surface, for small arc angles (<5°) that are typically associated with the leading edge, there is a considerable amount of insect residue accumulation. These results indicate a strong reduction in residue height and residue concentration for the inventive coating. Further, in the case of the inventive coating, the reductions are especially profound near the leading edge, where exoskeletons are most likely to occur in typical flight conditions. For arc angles exceeding 10°, insect residue on the inventive coating is also much less in terms of both heights and frequency.

The present invention includes the following nonlimiting aspects:

Aspect 1: A coating on a substrate, wherein the coating comprises, consists of, or consists essentially of a first layer that comprises, consists of, or consists essentially of a PAC; a second layer that comprises, consists of, or consists essentially of silicon dioxide nanoparticles and wherein the second layer is disposed adjacent to the first layer, wherein the first layer and the second layer are partially infused into one another.

Aspect 2: A coating of Aspect 1, wherein the coating is a super-hydrophobic coating.

Aspect 3: A coating of either Aspects 1 or 2, wherein the PAC is a hydrophobic PAC.

Aspect 4: A coating of any one of Aspects 1-3, wherein the PAC is a PMC.

Aspect 5: A coating of any one of Aspects 1-4, wherein the substrate is made of aluminum.

Aspect 6: A coating of any one of Aspects 1-5, wherein the first layer is between 8 and 10 microns thick.

Aspect 7: A coating of any one of Aspects 1-6, wherein the second layer is 300 nanometers or less thick.

Aspect 8: A coating of any one of Aspects 1-7, wherein the first layer is disposed between the substrate and the second layer.

Aspect 9: A coating of any one of Aspects 1-7, wherein the second layer is disposed between the substrate and the first layer.

Aspect 10: A coating of any one of Aspects 1-9, wherein the coating comprises, consists of, or consists essentially of a third layer that comprises, consists of, or consists essentially of a PAC and wherein the third layer is disposed adjacent to the second layer.

Aspect 11: A coating of Aspect 10, wherein the coating comprises, consists of, or consists essentially of a fourth layer that comprises, consists of, or consists essentially of silicon dioxide nanoparticles and wherein the fourth layer is disposed adjacent to the third layer.

Aspect 12: A coating of Aspect 11, wherein the coating comprises, consists of, or consists essentially of a fifth layer that comprises, consists of, or consists essentially of a PAC and wherein the fifth layer is disposed adjacent to the fourth layer.

Aspect 13: A coating of Aspect 12, wherein the coating comprises, consists of, or consists essentially of a sixth layer that comprises, consists of, or consists essentially of silicon dioxide nanoparticles and wherein the sixth layer is disposed adjacent to the fifth layer.

Aspect 14: A coating of Aspect 13, wherein the coating comprises, consists of, or consists essentially of a seventh layer that comprises, consists of, or consists essentially of a PAC and wherein the seventh layer is disposed adjacent to the sixth layer.

Aspect 15: A coating of Aspect 14, wherein the coating comprises, consists of, or consists essentially of an eighth layer that comprises, consists of, or consists essentially of silicon dioxide nanoparticles and wherein the eighth layer is disposed adjacent to the seventh layer.

Aspect 16: A coating of Aspect 15, wherein each of the first, second, third, fourth, fifth, sixth, sevenths, and eighth layers are partially infused into at least one adjacent layer.

Aspect 17: A coating of any one of Aspects 1-16, wherein the coating has no surface roughness features that are larger than 1 micron in size.

Aspect 18: A coating of any one of Aspects 1-17, wherein the average surface roughness of the coating is between 100 nm and 1 micron or wherein the average surface roughness of the coating is about 500 nm.

Aspect 19: A coating of any one of Aspects 1-18, wherein the coating has a total thickness of between 30 and 50 microns.

Aspect 20: A coating of any one of Aspects 1-19, wherein the coating has a pencil hardness value of at least 2B.

Aspect 21: A coating of any one of Aspects 1-20, wherein the coating adheres to the substrate with at least a 4B tape adhesion rating.

Aspect 22: A method of coating a substrate, wherein the method comprises, consists of, or consists essentially of: forming a first layer over the substrate, wherein forming the first layer includes spraying a first solution that comprises, consists of, or consists essentially of a PAC dissolved in a first solvent; forming a second layer over the substrate, wherein forming the second layer includes spraying a second solution onto a surface of the first layer, wherein the second solution comprises, consists of, or consists essentially of silicon dioxide nanoparticles and a second solvent; and heating the substrate, wherein heating the substrate results in the second layer partially infusing into the first layer, thereby forming the coating on the substrate.

Aspect 23: The method of Aspect 22, wherein the first solvent is acetone, THF, or MEK.

Aspect 24: The method of either Aspects 22 or 23, wherein the PAC is present in the first solution in an amount that is between 15 and 30 percent by weight of the first solution.

Aspect 25: The method of any one of Aspects 22-24, wherein the second solution comprises, consists of, or consists essentially of the silicon dioxide nanoparticles, the second solvent, and a PAC that is the same or different than the PAC of the first solution.

Aspect 26: The method of any one of Aspects 22-25, wherein the second solvent is acetone, THF, MEK, or chloroform.

Aspect 27: The method of any one of Aspects 22-26, wherein the second solution is a suspension and the method further comprises, consists of, or consists essentially of mixing the second solution before it is sprayed onto the surface of the first layer.

Aspect 28: The method of Aspect 27, wherein the method further comprises, consists of, or consists essentially of forming a third layer over the substrate, wherein forming the third layer includes spraying a third solution onto a surface of the second layer, wherein the third solution comprises, consists of, or consists essentially of a PAC dissolved in a third solvent.

Aspect 29: The method of Aspect 28, wherein the method further comprises, consists of, or consists essentially of forming a fourth layer over the substrate, wherein forming the fourth layer includes spraying a fourth solution onto a surface of the third layer, wherein the fourth solution comprises, consists of, or consists essentially of silicon dioxide nanoparticles and a fourth solvent.

Aspect 30: The method of Aspect 29, wherein the method further comprises, consists of, or consists essentially of forming a fifth layer over the substrate, wherein forming the fifth layer includes spraying a fifth solution onto a surface of the fourth layer, wherein the fifth solution comprises, consists of, or consists essentially of a PAC dissolved in a fifth solvent.

Aspect 31: The method of Aspect 30, wherein the method further comprises, consists of, or consists essentially of forming a sixth layer over the substrate, wherein forming the sixth layer includes spraying a sixth solution onto a surface of the fifth layer, wherein the sixth solution comprises, consists of, or consists essentially of silicon dioxide nanoparticles and a sixth solvent.

Aspect 32: The method of Aspect 31, wherein the method further comprises, consists of, or consists essentially of forming a seventh layer over the substrate, wherein forming the seventh layer includes spraying a seventh solution onto a surface of the sixth layer, wherein the seventh solution comprises, consists of, or consists essentially of a PAC dissolved in a seventh solvent.

Aspect 33: The method of Aspect 32, wherein the method further comprises, consists of, or consists essentially of forming an eighth layer over the substrate, wherein forming the eighth layer includes spraying an eighth solution onto a surface of the seventh layer, wherein the eighth solution comprises, consists of, or consists essentially of silicon dioxide nanoparticles and an eighth solvent.

Aspect 34: The method of Aspect 33, wherein the method further includes heating the substrate at least once after spraying one or more of third, fourth, fifth, sixth, seventh, and eighth solutions to partially infuse each of the third, fourth, fifth, sixth, seventh, or eighth layers into at least one adjacent layer.

Aspect 35: The method of either Aspects 33 or 34, wherein each of the second, fourth, sixth, and eighth layers are 300 nanometers or less thick.

Aspect 36: The method of any one of Aspects 33-35, wherein one or more of the first, second, third, fourth, fifth, sixth, seventh, and eighth solutions includes at least one co-solvent.

Aspect 37: The method of any one of Aspects 22-36, further comprising, consisting of, or consisting essentially of forming a makecoat on the substrate prior to forming the first layer over the substrate.

Aspect 38: The method of Aspect 37, wherein forming a first layer over the substrate comprises, consists of, or consists essentially of spraying the first solution onto the makecoat.

Aspect 39: The method of Aspect 37, wherein the method further comprises, consists of, or consists essentially of forming one or more additional layers on the makecoat before forming the first layer over the substrate, wherein the one or more additional layers are disposed between the makecoat and the first layer.

Aspect 40: The method of Aspect 39, wherein the one or more additional layers comprise, consist of, or consist essentially of a PAC.

Aspect 41: The method of either Aspects 39 or 40, wherein the one or more additional layers comprise, consist of, or consist essentially of silicon dioxide nanoparticles and a second solvent.

Aspect 42: The method of any one of Aspects 37-41, wherein the makecoat comprises, consists of, or consists essentially of a thermoplastic polymer or a heat activated adhesive.

Aspect 43: The method of any one of Aspects 37-42, wherein the makecoat comprises, consists of, or consists essentially of a PAC.

Aspect 44: The method of any one of Aspects 37-43, wherein the makecoat adheres to the substrate with an adhesion strength of approximately 1750 N/m based on 90° tape peel tests or wherein the makecoat adheres to the substrate with an adhesion strength of between approximately 1500 N/m and 2600 N/m.

Aspect 45: The method of any one of Aspects 37-44, wherein the solution is sprayed onto a surface of the makecoat while the makecoat is in a melted or semi-solid state.

Aspect 46: The method of any one of Aspects 22-45, wherein the coating has a total thickness of between 30 and 50 microns.

Aspect 47: The method of any one of Aspects 22-46, wherein the method further comprises, consists of, or consists essentially of removing non-stick portions of the second layer after the substrate has been heated.

Aspect 48: The method of Aspect 47, wherein removing non-stick portions of the second layer comprises, consists of, or consists essentially of removing non-stick portions with a pressure dust gun.

Aspect 49: A method of reducing insect residue on a surface, the method comprising, consisting of, or consisting essentially of disposing a coating according to any one of Aspects 1-21 over the surface, and allowing insects to impinge on the surface.

Aspect 50: The method of Aspect 49, wherein the surface is a surface on an aircraft.

Aspect 51: The method of either Aspects 49 or 51, wherein the surface is a surface on a turbine blade.

### Various Notes

Each of the non-limiting examples or aspects described herein can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A coating on a substrate, wherein the coating comprises:
a first layer that includes a perfluorinated acrylic copolymer;
a second layer that includes silicon dioxide nanoparticles and wherein the second layer is disposed adjacent to the first layer,
wherein the first layer and the second layer are partially infused into one another.

2. The coating of claim 1, wherein the coating is a super-hydrophobic coating.

3. The coating of claim 1, wherein the perfluorinated acrylic copolymer is a hydrophobic PMC.

4. The coating of claim 1, wherein the first layer is between 8 and 10 microns thick.

5. The coating of claim 1, wherein the second layer is 300 nanometers or less thick.

6. The coating of claim 1, wherein the first layer is disposed between the substrate and the second layer.

7. The coating of claim 1, wherein the coating further comprises
a third layer that includes a perfluorinated acrylic copolymer and wherein the third layer is disposed adjacent to the second layer; and
a fourth layer that includes silicon dioxide nanoparticles and wherein the fourth layer is disposed adjacent to the third layer.

8. The coating of claim 7, wherein the coating further comprises
a fifth layer that includes a perfluorinated acrylic copolymer and wherein the fifth layer is disposed adjacent to the fourth layer;
a sixth layer that includes silicon dioxide nanoparticles and wherein the sixth layer is disposed adjacent to the fifth layer;
a seventh layer that includes a perfluorinated acrylic copolymer and wherein the seventh layer is disposed adjacent to the sixth layer; and
an eighth layer that includes silicon dioxide nanoparticles and wherein the eighth layer is disposed adjacent to the seventh layer,
wherein each of the first, second, third, fourth, fifth, sixth, sevenths, and eighth layers are partially infused into at least one adjacent layer.

9. A method of coating a substrate, wherein the method comprises:
forming a first layer over the substrate, wherein forming the first layer includes spraying a first solution that includes perfluorinated acrylic copolymer dissolved in a first solvent;
forming a second layer over the substrate, wherein forming the second layer includes spraying a second solution onto a surface of the first layer, wherein the second solution includes silicon dioxide nanoparticles and a second solvent; and
heating the substrate, wherein heating the substrate results in the second layer partially infusing into the first layer, thereby forming the coating on the substrate.

10. The method of claim 9, wherein the first solvent is acetone, THF, or MEK.

11. The method of claim 9, wherein the perfluorinated acrylic copolymer is present in the first solution in an amount that is between 15 and 30 percent by weight of the first solution.

12. The method of claim 9, wherein the second solvent is acetone, THF, MEK, or chloroform.

13. The method of claim 9, wherein the method further comprises
forming a third layer over the substrate, wherein forming the third layer includes spraying a third solution onto a surface of the second layer, wherein the third solution includes perfluorinated acrylic copolymer dissolved in a third solvent; and
forming a fourth layer over the substrate, wherein forming the fourth layer includes spraying a fourth solution onto a surface of the third layer, wherein the fourth solution includes silicon dioxide nanoparticles and a fourth solvent.

14. The method of claim 13, wherein the method further comprises,
forming a fifth layer over the substrate, wherein forming the fifth layer includes spraying a fifth solution onto a surface of the fourth layer, wherein the fifth solution includes perfluorinated acrylic copolymer dissolved in a fifth solvent;
forming a sixth layer over the substrate, wherein forming the sixth layer includes spraying a sixth solution onto a surface of the fifth layer, wherein the sixth solution includes silicon dioxide nanoparticles and a sixth solvent;
forming a seventh layer over the substrate, wherein forming the seventh layer includes spraying a seventh solution onto a surface of the sixth layer, wherein the seventh solution includes perfluorinated acrylic copolymer dissolved in a seventh solvent; and
forming an eighth layer over the substrate, wherein forming the eighth layer includes spraying an eighth solution onto a surface of the seventh layer, wherein the eighth solution includes silicon dioxide nanoparticles and an eighth solvent.

15. The method of claim 14, wherein the method further includes heating the substrate at least once after spraying one or more of third, fourth, fifth, sixth, seventh, and eighth solutions to partially infuse each of the third, fourth, fifth, sixth, seventh, or eighth layers into at least one adjacent layer.

16. The method of claim 9, wherein the coating has a total thickness of between 30 and 50 microns.

17. The method of claim 9, wherein the method further comprises removing non-stick portions of the second layer after the substrate has been heated.

18. The method of claim 17, wherein removing non-stick portions of the second layer includes removing non-stick portions with a pressure dust gun.

19. A method of reducing insect residue on a surface, the method comprising, consisting of, or consisting essentially of
disposing a coating according to claim 1 over the surface, and allowing insects to impinge on the surface.

20. The method of claim 19, wherein the surface is a surface on a turbine or an aircraft.
